(19) United States
(12) Patent Application Publication
(10) Pub. No.: US 2017/0153593 A1
(43) Pub. Date: Jun. 1, 2017

(54) FIXING DEVICE AND IMAGE FORMING APPARATUS INCLUDING THE SAME

(71) Applicant: KYOCERA Document Solutions Inc., Osaka (JP)

(72) Inventor: Tomohiro WATATANI, Osaka (JP)

(21) Appl. No.: 15/352,865

(22) Filed: Nov. 16, 2016

(30) Foreign Application Priority Data
Nov. 30, 2015 (JP) 2015-234186

(51) Int. Cl. G03G 15/00; G03G 15/20

(52) U.S. Cl. CPC G03G 15/70; G03G 15/2028

(57) ABSTRACT

A fixing device includes a clutch provided between a driving motor and a rotary cam, and a control unit. In a case in which press-contact force of the pressure roller is a high load, when a jam state has been detected, the control unit transmits power to the rotary cam by switching the clutch to a power transmission state, and stops the driving motor at the time of rotation of the rotary cam by a predetermined angle.

### CROSS-REFERENCE TO RELATED APPLICATION

This application is based upon and claims the benefit of priority from Japanese Patent Application No. 2015-234186 filed on Nov. 30, 2015, the entire contents of which are incorporated herein by reference.

### BACKGROUND

The technology of the present disclosure relates to a fixing device and an image forming apparatus including the same.

Conventionally, an electrophotographic type image forming apparatus is mounted with a fixing device that fixes a toner image to a recording paper by heating and pressing the toner image. The fixing device has a rotatable fixing roller, a pressure roller brought into press contact with the fixing roller, and a casing having the fixing roller and the pressure roller therein. The fixing roller is heated by a heating means such as a halogen lamp. The recording paper passes through between the fixing roller and the pressure roller, so that the toner image on the recording paper is heated and pressed and is fixed to the recording paper.

In this type of fixing device, there is a case in which a special paper, such as an envelope having a thickness larger than that of a plain paper, is used as the recording paper. When such a special paper is used, if press-contact force between the fixing roller and the pressure roller is set to be equal to that in a fixing process for the plain paper, wrinkles may occur in the special paper. In order to avoid this problem, there has been proposed a fixing device provided with a pressure switching mechanism that switches the press-contact force between the fixing roller and the pressure roller to a low load and a high load.

### SUMMARY

A fixing device according to one aspect of the present disclosure includes a fixing roller, a pressure roller, a pressure switching mechanism, and a jam detection unit. The fixing roller is rotationally driven by a driving motor. The pressure roller is brought into press contact with the fixing roller to form a nip portion. The pressure switching mechanism switches press-contact force between the two rollers to a low load and a high load by rotating a rotary cam. The jam detection unit detects a jam state in which a sheet has been jammed with the sheet being interposed between the fixing roller and the pressure roller.

The driving motor serves as a motor for driving the rotary cam. The fixing device further includes a clutch and a control unit. The clutch is provided between the driving motor and the rotary cam. The control unit stops the driving motor while maintaining the clutch in a blocking state when the jam state has been detected by the jam detection unit in a case in which the press-contact force of the pressure roller is the low load, and transmits power to the rotary cam by switching the clutch to a power transmission state and stops the driving motor at the time of rotation of the rotary cam by a predetermined angle when the jam state has been detected by the jam detection unit in a case in which the press-contact force of the pressure roller is the high load.

### BRIEF DESCRIPTION OF THE DRAWINGS

FIG. 1 is a schematic configuration diagram illustrating an image forming apparatus including a fixing device in an embodiment.

FIG. 2 is a diagram illustrating a driving mechanism of a rotating member in an image forming apparatus, which is a view viewed from an outer side of the image forming apparatus.

FIG. 3 is a diagram illustrating a driving mechanism of a rotating member in an image forming apparatus, which is a view viewed from an inner side (a back side in a direction vertical to a paper surface of FIG. 2) of the image forming apparatus.

FIG. 4 is an external appearance perspective view of a fixing device illustrating a state in which press-contact force between a fixing roller and a pressure roller is a low load.

FIG. 5 is an external appearance perspective view of a fixing device illustrating a state in which press-contact force between a fixing roller and a pressure roller is a high load.

FIG. 6 is an enlarged perspective view illustrating a phase detection member attached to one end portion of a cam driving shaft.

FIG. 7 is an enlarged perspective view illustrating a phase detection member attached to one end portion of a cam driving shaft.

FIG. 8 is a flowchart illustrating details of jam processing control in a controller.

FIG. 9 is a schematic diagram for explaining a state of a recording paper at the time of stop of a motor.

### DETAILED DESCRIPTION

Hereinafter, an example of an embodiment of the technology of the present disclosure will be described on the basis of the drawings.

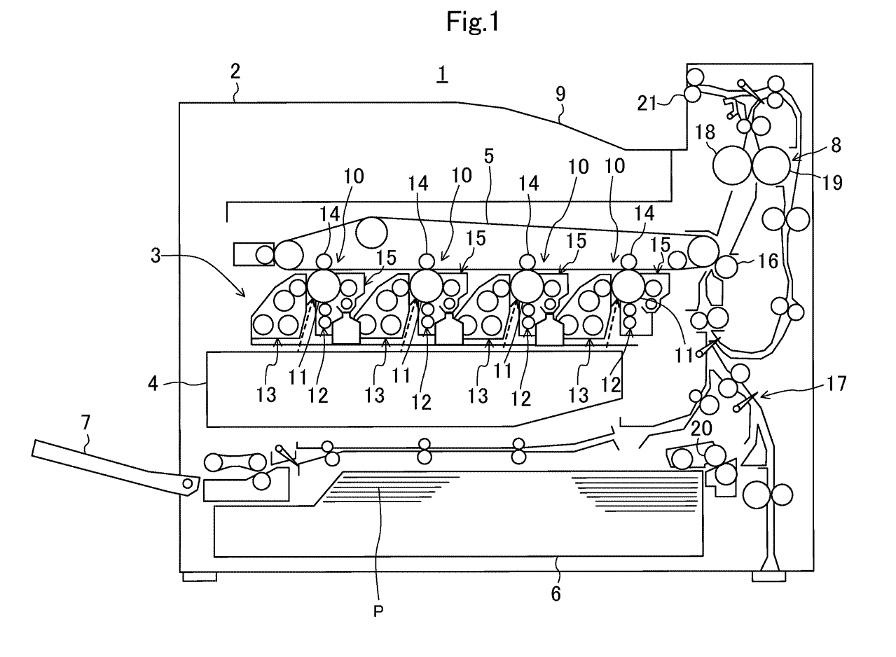

FIG. 1 illustrates a schematic configuration diagram of an image forming apparatus 1. The image forming apparatus 1 is a tandem type color printer and includes an image forming unit 3 in a box-like casing 2. The image forming unit 3 transfers an image to a recording paper P and forms the image on the recording paper P on the basis of image data transmitted from an external device such as a computer subjected to network connection and the like. Below the image forming unit 3, an exposure device 4 is arranged to irradiate laser light, and above the image forming unit 3, an intermediate transfer belt 5 is arranged. Below the exposure device 4, a paper storage unit 6 is arranged to store a recording paper P, and at a lateral side of the paper storage unit 6, a manual paper feeding unit 7 is arranged. At a lateral upper part of the intermediate transfer belt 5, a fixing unit 8 is arranged to perform a fixing process on the image transferred to and formed on the recording paper P. A reference numeral 9 indicates a paper discharge unit arranged at an upper portion of the casing 2 to discharge the recording paper P subjected to the fixing process in the fixing unit 8.

The image forming unit 3 includes four image forming units 10 arranged in a row along the intermediate transfer belt 5. Each of the image forming units 10 has a photosensitive drum 11. Directly under each photosensitive drum 11, a charging device 12 is arranged, and at one side of each photosensitive drum 11, a developing device 13 is arranged. Directly above each photosensitive drum 11, a primary transfer roller 14 is arranged, and at the other side of each photosensitive drum 11, a cleaning unit 15 is arranged to clean the peripheral surface of the photosensitive drum 11.

The peripheral surface of each photosensitive drum 11 is uniformly charged by the charging device 12, and laser light corresponding to each color based on the image data inputted from the aforementioned computer and the like is irradiated to the charged peripheral surface of each photosensitive drum 11 from the exposure device 4, so that an electrostatic latent image is formed on the peripheral surface of each photosensitive drum 11. A developer is supplied to the electrostatic latent image from the developing device 13, so that a toner image of yellow, magenta, cyan, or black is formed on the peripheral surface of each photosensitive drum 11. These toner images are respectively superposed on and transferred to the intermediate transfer belt 5 by a transfer bias applied to the primary transfer roller 14.

A reference numeral 16 indicates a secondary transfer roller arranged below the fixing unit 8 in the state of abutting the intermediate transfer belt 5. The recording paper P conveyed along a paper conveyance path 17 from the paper storage unit 6 or the manual paper feeding unit 7 is interposed between the secondary transfer roller 16 and the intermediate transfer belt 5. Then, the toner images on the intermediate transfer belt 5 are transferred to the recording paper P by a transfer bias applied to the secondary transfer roller 16.

The fixing unit 8 includes a fixing roller 18 and a pressure roller 19, wherein the recording paper P is interposed by the fixing roller 18 and the pressure roller 19 so as to be heated and pressed, so that the toner images, which have been transferred to the recording paper P, are fixed to the recording paper P. The recording paper P subjected to the fixing process is discharged to the paper discharge unit 9.

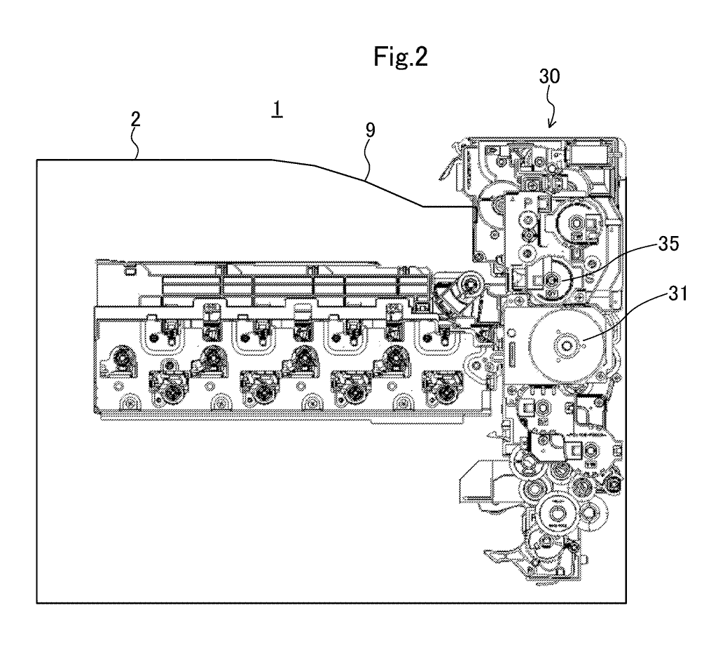

FIG. 2 is a side view when a driving mechanism 30 of a rotating member in the image forming apparatus 1 is viewed from an outer side of the image forming apparatus 1. The driving mechanism 30 has one motor 31 as a driving source. The motor 31 is connected to all rotating members, which include a paper feeding roller 20 (see FIG. 1), a paper discharge roller 21, the fixing unit 8, the intermediate transfer belt 5, the primary transfer roller 14, the secondary transfer roller 16 and the like, via a gear mechanism, a clutch and the like.

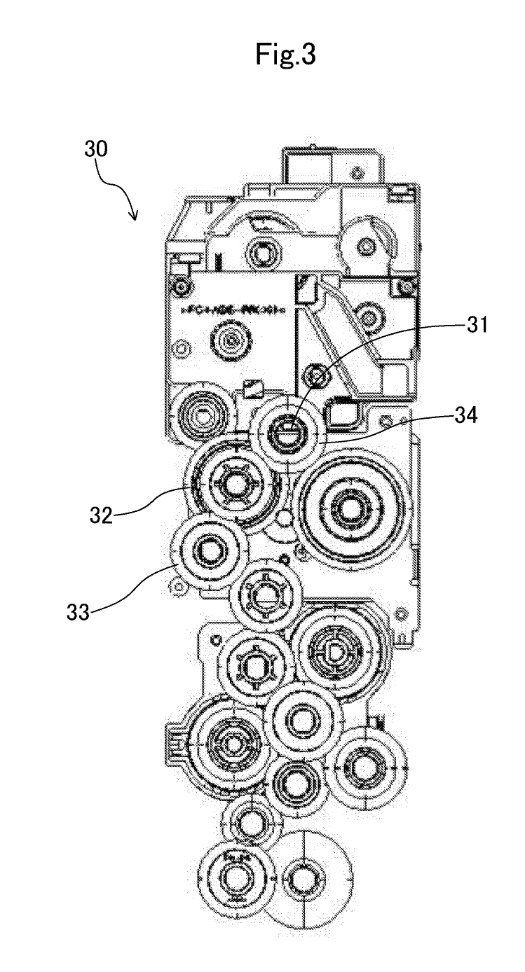

FIG. 3 is a side view when the driving mechanism 30 is viewed from an inner side of the image forming apparatus 1. A reference numeral 32 of the drawing indicates fixing gears that are fixed to the aforementioned fixing roller 18 and transmit rotary driving force to the fixing roller 18, and a reference numeral 33 indicates a pressure switching gear that transmits driving force to a pressure switching mechanism 50 to be described later. The aforementioned fixing gears 32 engage with motor gears 34 attached to an output shaft of the motor 31. The pressure switching gear 33 is connected to the output shaft of the motor 31 via a plurality of gears (not illustrated) and an electromagnetic clutch 35 (see FIG. 2). The aforementioned electromagnetic clutch 35 can be switched to a power transmission state in which power of the motor 31 is transmitted to the pressure switching gear 33 and a blocking state in which the power transmission is blocked. The electromagnetic clutch 35 is maintained in the blocking state while the fixing process is being performed by the fixing unit 8. The operations of the electromagnetic clutch 35 and the motor 31 are controlled by a controller 100 to be described later.

The aforementioned fixing unit 8 has a high pressure mode in which press-contact force between the fixing roller 18 and the pressure roller 19 becomes a high load and a low pressure mode in which the press-contact force becomes a low load smaller than the high load. The fixing unit 8 is provided with the pressure switching mechanism 50 for switching these two modes. When a plain paper print mode has been selected by a non-illustrated operation unit (including a liquid crystal touch panel and a user operation button for example), a pressing mode of the fixing unit 8 is set to the high pressure mode by the pressure switching mechanism 50, and when a special paper print mode has been set by the operation unit, the pressing mode of the fixing unit 8 is set to the low pressure mode by the pressure switching mechanism 50. In this way, when a special paper (for example, an envelope and an OHP sheet) having a thickness larger than that of a plain paper is printed, wrinkles are prevented from occurring in the special paper by excessive press-contact force between the two rollers 18 and 19.

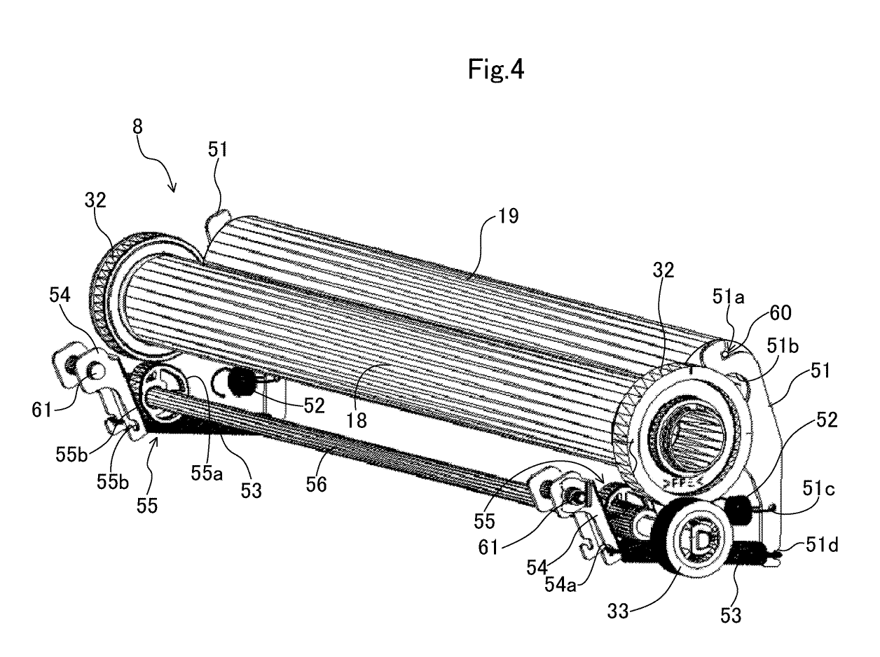

FIG. 4 is an external appearance perspective view of the fixing unit 8 including the aforementioned pressure switching mechanism 50. The fixing roller 18 and the pressure roller 19 form a cylindrical shape extending in the front and rear direction of the image forming apparatus 1. At both end portions in the axial direction of the fixing roller 18, the aforementioned fixing gears 32 engaging with the motor gears are fixed. The fixing roller 18 rotates by receiving driving force from the motor 31 via the fixing gears 32. The pressure roller 19 rotates in accordance with the fixing roller 18.

As illustrated in FIG. 4, the pressure switching mechanism 50 has pressure levers 51, a first tension coil spring 52, a second tension coil spring 53, a swing lever 54, rotary cams 55, and a cam shaft 56. Two pressure levers 51 are provided spaced apart from each other in the front and rear direction. Each pressure lever 51 includes a plate material made of a sheet metal, which is long in the vertical direction. Each pressure lever 51 is formed at an upper end portion thereof with a fulcrum groove 51a. The fulcrum groove 51a engages with a first support shaft 60 fixed to a housing (not illustrated), so that the pressure levers 51 can rotate around the first support shaft 60.

At a slightly lower side of the upper end portion of each pressure lever 51 from the fulcrum groove 51a, a bearing hole 51b is formed to rotatably support a roller shaft of the pressure roller 19. At a lower end portion (a lower side from the bearing hole 51b) of each pressure lever 51, a spring locking hole 51c and a spring locking groove 51d are vertically formed in a line.

One end portion of the first tension coil spring 52 is locked to the spring locking hole 51c. The other end portion of the first tension coil spring 52 is fixed to a fixing member (not illustrated) positioned at the fixing roller 18 side of the pressure lever 51.

The spring locking groove 51d is formed below the spring locking hole 51c, and one end portion of the second tension coil spring 53 is locked to the spring locking groove 51d. The other end portion of the second tension coil spring 53 is locked to a locking groove 54a of a lower end portion of the swing lever 54.

The upper end portion of the swing lever 54 is rotatably supported to a second support shaft 61 fixed to the housing (not illustrated).

The rotary cams 55 are fixed to both end portions of the cam shaft 56 extending in parallel to the fixing roller 18. Each rotary cam 55 is formed in an approximately oval plate shape having a maximum diameter part 55a and a minimum diameter part 55b. The maximum diameter part 55a and the minimum diameter part 55b of each rotary cam 55 are arranged at an opposite side by 180° while interposing an axis center of the rotary cams 55 therebetween.

FIG. 4 illustrates a state in which the minimum diameter parts 55b of the rotary cams 55 have abutted the swing levers 54. In this state, a spring length of the first tension coil spring 52 is longer than a natural length and a spring length of the second tension coil spring 53 coincides with the natural length. Consequently, in the state of FIG. 4, only the spring force of the first tension coil springs 52 acts on the pressure levers 51. The pressure levers 51 are urged in a clockwise direction of the drawing by the spring force of the first tension coil springs 52 by employing the first support shaft 60 as a fulcrum. In this way, the pressure roller 19 held in the bearing holes 51b of the pressure levers 51 are pressed to the fixing roller 18 with a low load. That is, in the state of FIG. 4, the pressing mode of the fixing unit 8 is the low pressure mode.

At one end portion in the axial direction of the aforementioned cam shaft 56, the aforementioned pressure switching gear 33 is fixed. The pressure switching gear 33 is connected to the motor 31 via the plurality of gears and the electromagnetic clutch 35 as described above. When the cam shaft 56 and the rotary cams 55 are rotationally driven by the motor 31 from the state of FIG. 4, the swing levers 54 are pressed by the peripheral surfaces of the rotary cams 55, so that the swing levers 54 rotate about the second support shaft in the clockwise direction of FIG. 4 against the urging force of the second tension coil springs 53.

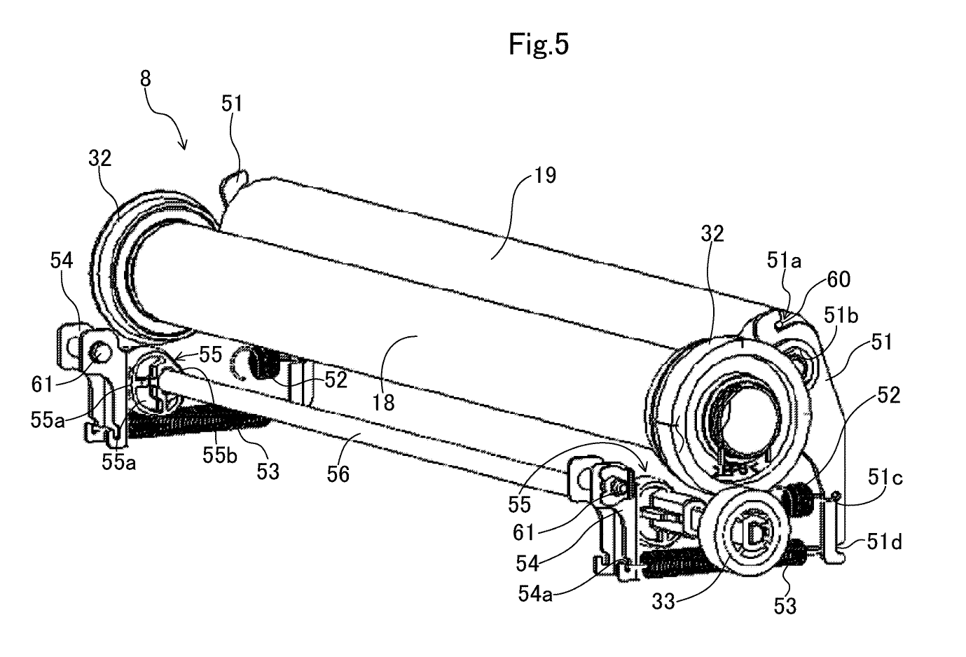

When the rotary cams 55 rotate by 180° from the state of FIG. 4, the maximum diameter parts 55a of the rotary cam 55 enter a state of abutting the swing levers 54 as illustrated in FIG. 5. In this state, since the second tension coil springs 53 become longer than the natural length, the spring force of both the first tension coil springs 52 and the second tension coil springs 53 acts on the pressure levers 51. In this way, the pressure roller 19 held in the bearing holes 51b of the pressure levers 51 are pressed to the fixing roller 18 with a high load (a load larger than the aforementioned low load). Accordingly, the pressing mode of the fixing unit 8 is switched to the high pressure mode from the low pressure mode.

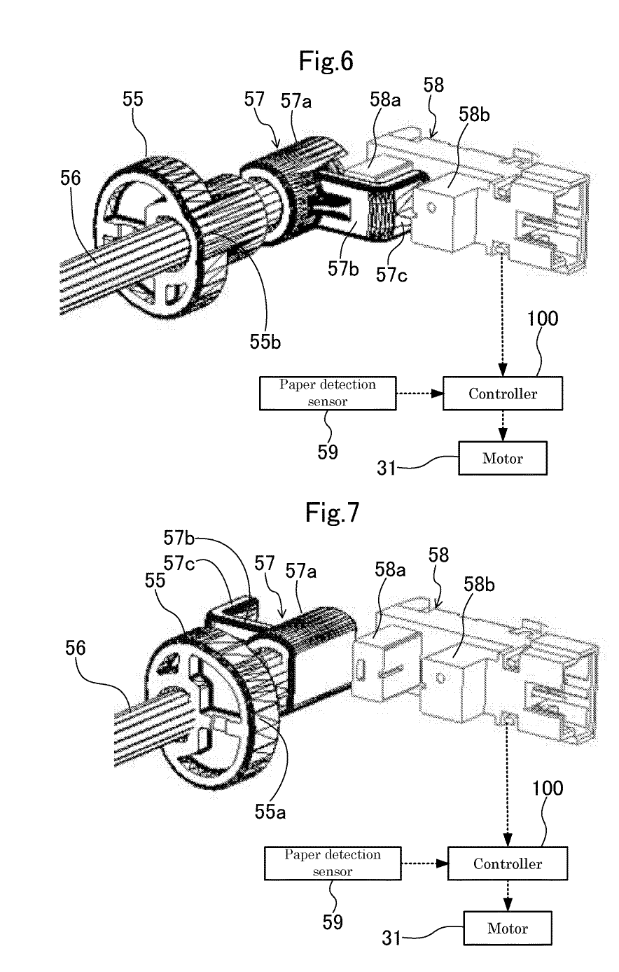

As illustrated in FIG. 6 and FIG. 7, a phase detection member 57 is attached to an end portion opposite to an end portion of the pressure switching gear 33 side in the cam shaft 56. The phase detection member 57 has a cylindrical part 57a integrally and rotatably fitted around an end portion of the cam shaft 56, a connection plate part 57b protruding radially outside from an outer peripheral surface of the cylindrical part 57a, and a light blocking plate part 57c bent from a front end portion of the connection plate part 57b at a right angle. The phase detection member 57 is provided at a lateral side thereof with a PI sensor (corresponding to a detection sensor) 58 having a light emitting part 58a and a light receiving part 58b. The PI sensor 58 outputs a light transmitting signal when a light transmitting state is formed between the light emitting part 58a and the light receiving part 58b, and outputs a light blocking signal when a light blocking state is formed between the light emitting part 58a and the light receiving part 58b.

In the present embodiment, in the state in which the pressing mode of the fixing unit 8 has been set to the high pressure mode (in the state in which the maximum diameter parts 55a of the rotary cam 55 abuts the swing levers 54), a space between the light emitting part 58a and the light receiving part 58b of the PI sensor 58 is blocked by the light blocking plate part 57c of the phase detection member 57 as illustrated in FIG. 6, so that the light blocking signal is outputted by the PI sensor 58. On the other hand, in the state in which the pressing mode of the fixing unit 8 has been set to the low pressure mode (in the state in which the minimum diameter part 55b of the rotary cam 55 abuts the swing levers 54), the aforementioned light blocking plate part 57c moves outward from between the light emitting part 58a and the light receiving part 58b of the PI sensor 58 as illustrated in FIG. 7, so that the light transmitting signal is outputted from the PI sensor 58. The signals outputted from the PI sensor 58 are transmitted to the controller 100.

The controller 100 includes a microcomputer having a CPU, a ROM, a RAM and the like. The controller 100 is electrically connected to a paper detection sensor 59 provided at a downstream side of the fixing unit 8, in addition to the PI sensor 58. The paper detection sensor 59, for example, is configured by a reflective optical sensor, and the controller 100 predicts a time at which a front end portion of the recording paper P reaches the paper detection sensor 59 after passing through a nip portion between the fixing roller 18 and the pressure roller 19, and determines that a jam state has occurred when the recording paper P is not detected by the paper detection sensor 59 even after a predetermined time passes from the prediction time. Here, the jam state refers to a state in which paper jam occurs with the recording paper P being interposed between the fixing roller 18 and the pressure roller 19. When it is detected that the jam state has occurred, the controller 100 performs jam processing control such that a user can easily perform jam processing (removal processing of the recording paper P). The controller 100 corresponds to a control unit and the controller 100 and the paper detection sensor 59 correspond to a jam detection unit.

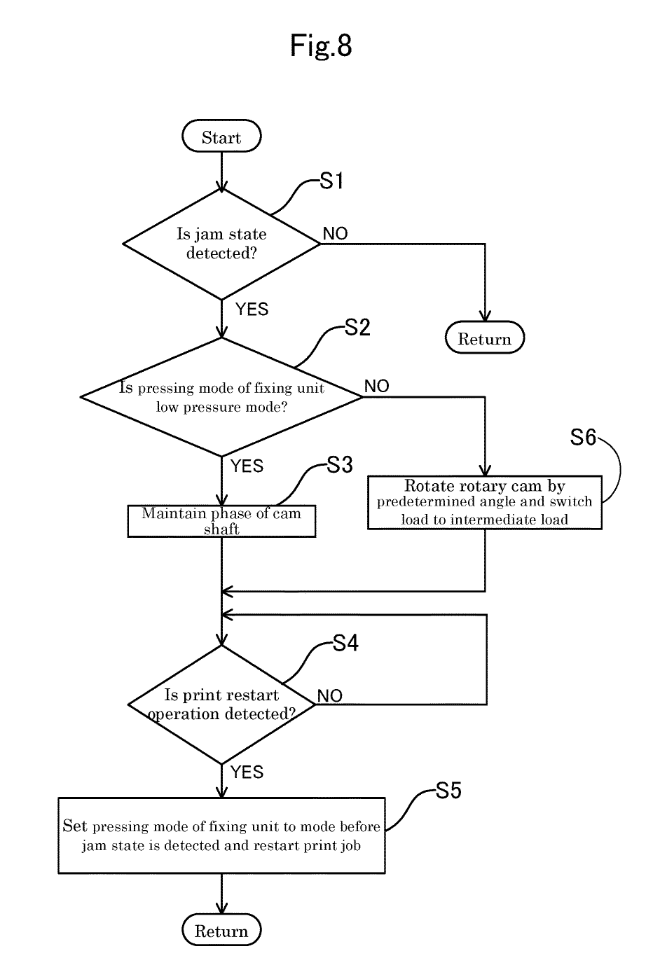

FIG. 8 is a flowchart illustrating details of the jam processing control in the controller 100.

In an initial step S1, it is determined whether a jam state has occurred based on a signal from the paper detection sensor 59. When this determination is NO, the procedure returns, and when this determination is YES, the procedure proceeds to step S2.

In step S2, it is determined whether a current pressing mode of the fixing unit 8 is the low pressure mode. When this determination is NO, the procedure proceeds to step S6, and when this determination is YES, the procedure proceeds to step S3.

In step S3, the electromagnetic clutch 35 is maintained in the blocking state to hold a phase angle of the cam shaft 56 to a phase angle at the present time, and driving of the motor 31 is stopped, so that a print job being performed is stopped.

In step S4, it is determined whether a print restart operation (for example, a pressing operation of a print button provided to an operation panel) has been performed by a user, based on an operation signal from the operation panel. When this determination is NO, the process of the present step S4 is performed again, and when this determination is YES, the procedure proceeds to step S5.

In step S5, the pressing mode of the fixing unit 8 is set to a mode before the jam state is detected in step S1, so that a print process is restarted.

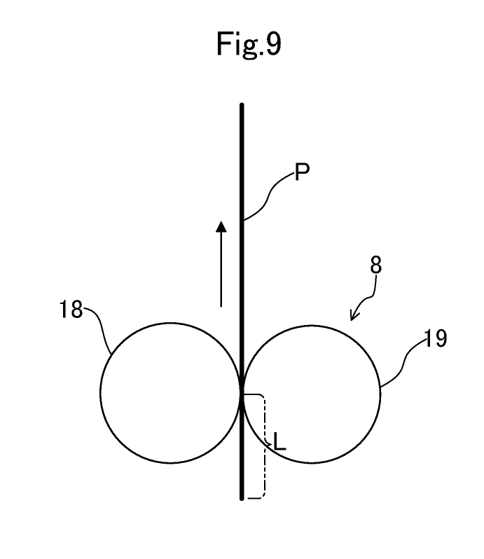

In step S6 which is performed when the determination of step S2 is NO (that is, when the pressing mode of the fixing unit 8 is the high pressure mode), the electromagnetic clutch 35 is switched to the power transmission state, so that the driving force of the motor 31 is transmitted to the cam shaft 56. Then, when the rotary cams 55 has rotated by a predetermined angle (90° in the present embodiment) from the switching, the driving of the motor 31 is stopped, so that a print job is stopped. The predetermined angle is set such that a paper remains longer than a predetermined length L at an upstream side from the nip portion between the fixing roller 18 and the pressure roller 19 at the time of the stop of the motor 31 (see FIG. 9). The aforementioned predetermined angle is set such that the press-contact force between the fixing roller 18 and the pressure roller 19 is an intermediate load between the low load and the high load at the time of the stop of the motor 31. The stop timing of the motor 31, for example, is decided by timer control employing the time when the output signal of the PI sensor 58 has switched from the light blocking signal to the light transmitting signal as a reference.

As described above, in the aforementioned embodiment, when the fixing unit 8 enters the high pressure mode (when the press-contact force between the fixing roller 18 and the pressure roller 19 is the high load), if the jam state has been detected by the controller 100, the electromagnetic clutch 35 is switched from the blocking state to the power transmission state to rotate the rotary cams 55 by the predetermined angle, so that the press-contact force between the fixing roller 18 and the pressure roller 19 is switched to the intermediate load between the low load and the high load and thus the driving motor 31 is stopped at the time of completion of the switching (step S6).

According to this, it is possible to minimize holding force between the fixing roller 18 and the pressure roller 19, which acts on the recording paper P at the time of the stop of the motor 31. Thus, when a user removes the recording paper P from between the two rollers 18 and 19, it is possible to reliably prevent the recording paper P from being torn. Furthermore, as compared with the case in which the press-contact force between the fixing roller 18 and the pressure roller 19 is switched from the high pressure load to the low pressure load, it is possible to reduce the rotation amount (that is, a conveyance distance of the recording paper P) of the motor 31 from the start to the end of the load switching. Consequently, it is possible to prevent the rear end of the recording paper P from moving downward from the nip portion between the two rollers 18 and 19 at the time of the stop of the motor 31. In other words, it is possible to allow the rear end portion of the recording paper P to remain longer the predetermined length L at an upstream side from the nip portion between the two rollers 18 and 19 at the time of the stop of the motor 31. Consequently, a user can easily grasp the rear side portion of the recording paper P with his/her hands when performing the jam process. Thus, it is possible to facilitate jam processing work.

Furthermore, it is possible to prevent the recording paper P from being wound to the fixing roller 18 when the motor 31 is continuously rotated in a forcible manner.

On the other hand, in the case in which the fixing unit 8 is in the low pressure mode (when the press-contact force between the fixing roller 18 and the pressure roller 19 is the low load), when the jam state has been detected by the controller 100, the motor 31 is stopped without switching the electromagnetic clutch 35 to the power transmission state (in the state in which the electromagnetic clutch 35 has been maintained in the blocking state) (step S3). Consequently, it is possible to stop the conveyance of the recording paper P by stopping the motor 31 immediately after the jam state occurs. Thus, it is possible to prevent a secondary problem that the recording paper P is wound to the fixing roller 18, and to facilitate jam processing work of a user by allowing the rear end portion of the recording paper P to sufficiently remain at an upstream side from the nip portion between the fixing roller 18 and the pressure roller 19.

Moreover, in the aforementioned embodiment, the motor 31 is also used as a driving motor for driving the rotating member (the paper feeding roller 20, the paper discharge roller 21, the fixing unit 8, the intermediate transfer belt 5, the primary transfer roller 14, the secondary transfer roller and the like) of the image forming apparatus 1. Consequently, it is possible to achieve a low cost by reducing the number of parts as compared with the case in which a motor dedicated for the fixing unit 8 is provided.

Furthermore, in the aforementioned embodiment, the pressure switching mechanism 50 is configured to be able to switch the press-contact force between the aforementioned two rollers 18 and 19 to the high pressure load and the low pressure load by rotating the rotary cams by 180°, and the aforementioned angle is set to 90° which is a half of 180°.

According to this, it is possible to allow the rear end portion of the recording paper P to sufficiently remain at an upstream side from the nip portion between the two rollers 18 and 19 at the time of the stop of the motor 31 while sufficiently reducing the holding force of the recording paper P by the two rollers 18 and 19.

Furthermore, in the aforementioned embodiment, the controller 100 is configured to decide the stop timing of the aforementioned motor 31 based on the output signal from the PI (detection sensor) 58 (step S6). In this way, it is possible to accurately control the stop timing of the motor 31.

What is claimed is:

1. A fixing device comprising:
a fixing roller rotationally driven by a driving motor;
a pressure roller brought into press contact with the fixing roller to form a nip portion;
a pressure switching mechanism that switches press-contact force between the fixing roller and the pressure roller to a low load and a high load by rotating a rotary cam; and
a jam detection unit that detects a jam state in which a sheet has been interposed and clogged between the fixing roller and the pressure roller,
wherein the driving motor serves as a motor for driving the rotary cam, and
the fixing device further comprises:
a clutch provided between the driving motor and the rotary cam; and
a control unit that stops the driving motor while maintaining the clutch in a blocking state when the jam state has been detected by the jam detection unit in a case in which the press-contact force of the pressure roller is the low load, and transmits power to the rotary cam by switching the clutch to a power transmission state, stops the driving motor at a time of rotation of the rotary cam by a predetermined angle, and switches the press-contact force of the pressure roller to an intermediate load between the low load and the high load when the jam state has been detected by the jam detection unit in a case in which the press-contact force of the pressure roller is the high load.

2. The fixing device of claim 1, wherein the driving motor serves as a motor for driving a rotating member provided to an apparatus mounted with the fixing device.

3. The fixing device of claim 1, wherein the pressure switching mechanism is configured to be able to switch the press-contact force between the fixing roller and the pressure roller to a high pressure load and a low pressure load by rotating the rotary cam by 180°, and the predetermined angle is 90°.

4. The fixing device of claim 3, further comprising:
a cam shaft connected to the rotary cam;
a phase detection member fixed to the cam shaft; and
a detection sensor that detects the phase detection member,
wherein, when the jam state has been detected by the jam detection unit in the case in which the press-contact force of the pressure roller is the high load, the control unit is configured to decide a stop timing of the driving motor based on an output signal from the detection sensor.

5. An image forming apparatus including the fixing device of claim 1.
